(19) United States
(12) Patent Application Publication
(10) Pub. No.: US 2025/0051940 A1
(43) Pub. Date: Feb. 13, 2025

(54) FeNi ALLOY-BASED ELECTROCATALYST FOR WATER OXIDATION

(71) Applicant: KING FAHD UNIVERSITY OF PETROLEUM AND MINERALS, Dhahran (SA)

(72) Inventors: Muhammad Ali EHSAN, Dhahran (SA); Abuzar KHAN, Dhahran (SA)

(73) Assignee: KING FAHD UNIVERSITY OF PETROLEUM AND MINERALS, Dhahran (SA)

(21) Appl. No.: 18/448,681

(22) Filed: Aug. 11, 2023

(51) Int. Cl. C25B 11/089; C25B 1/04; C25B 11/02; C25B 11/061

(52) U.S. Cl. CPC C25B 11/089; C25B 1/04; C25B 11/02; C25B 11/061

(57) ABSTRACT

A method of generating oxygen including applying a potential of greater than 0 to 2.0 V to an electrochemical cell. The electrochemical cell is at least partially submerged in an aqueous solution, where on applying the potential the aqueous solution is oxidized thereby forming oxygen. The electrochemical cell includes an electrocatalyst; and a counter electrode. The electrocatalyst includes a nickel foam substrate; and a layer of particles of a FeNi alloy on the surface of the nickel foam substrate, where the particles of the FeNi alloy are in the form of nanosheets, where the nanosheets have average width of 1-5 μm and an average length of 1-10 μm, and where the nanosheets are vertically aligned to form a flower shape.

### STATEMENT OF ACKNOWLEDGEMENT

Support provided by King Fahd University of Petroleum and Minerals (KFUPM) is gratefully acknowledged.

### BACKGROUND

### Technical Field

The present disclosure is directed to an electrocatalyst, particularly to a method of generating oxygen using a FeNi alloy-based electrocatalyst.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Hydrogen is widely recognized as a renewable and sustainable energy source due to its properties, such as high energy density, non-polluting, and lightweight nature. It is abundantly available in water and can be produced by breaking the bond between oxygen and hydrogen. This process, known as electrochemical water splitting, is a two-step process including hydrogen evolution reaction (HER) and oxygen evolution reaction (OER) steps, which happen at the cathode and anode, respectively. Of these, more importance is given to OER because of its complicated electron-proton shifting process, which slows down the reaction kinetics and requires a high overpotential to achieve. To minimize these over-potentials, highly efficient, long-lived, inexpensive, and abundant electrocatalyst materials are required. Some rare earth metal oxides (IrO₂, RuO₂, etc.) are known as top-level catalysts for OER processes, but their high price and insufficient supply limit their utilization for large-scale applications. Therefore, developing affordable and sustainable electrocatalyst materials is necessary.

In this regard, electrocatalysts with first row 3d transition metals (Fe, Co, and Ni) have attracted attention because of their excellent electrical properties, low cost, and accessibility. A major challenge for OER is the low conductivity and stability of Ni-based catalysts. To address this issue, Ni can be alloyed with other 3d transition metals, which can enhance the electronic and structural properties of the catalysts. The alloying of different metals can induce various effects, such as lattice strain, electronic structure modulation, ligand effect, ensemble effect, and synergistic effect, which can alter the adsorption and activation of reactants and intermediates on the catalyst surface. These effects can enhance or weaken the binding strength of certain species, thus tuning the catalytic activity and selectivity. Moreover, the composition, size, and morphology of alloy electrocatalysts can also affect their catalytic properties by changing the surface area, exposed facets, and coordination environment of active sites. Catalysts including alloys of Fe and Ni, and their oxides have shown great promise.

It has been observed that previous OER studies based on FeNi electrocatalysts used nanopowders, which require polymer binders (such as Nafion) for better adhesion with the current collector. The addition of binder covers the active sites of the catalyst and causes its deactivation. Meanwhile, it increases the resistance between the catalyst and the current collector and hinders the easy transfer of electrons, thereby deteriorating the conductivity. Moreover, such bonded catalysts are not mechanically stable, and the catalyst easily flakes off under severe oxygen evolution conditions, particularly when higher current densities are applied. These issues need to be solved to understand the full potential of nanostructured catalysts.

In view of the forgoing, one objective of the present invention is to provide an electrocatalyst including an Fe and Ni alloy. It is another object of the present disclosure is to develop an electrocatalyst which obviates the need for the use of polymeric binders but is capable of achieving high conductivity and improved electrocatalytic activity. It is another object of the present disclosure to provide a Fe and Ni alloy electrocatalyst with a cheap and efficient method of making.

### SUMMARY

In an exemplary embodiment, a method of generating oxygen is described. The method includes applying a potential of greater than 0 to 2.0 V to an electrochemical cell, wherein the electrochemical cell is at least partially submerged in an aqueous solution, wherein on applying the potential the aqueous solution is oxidized, thereby forming oxygen. The electrochemical cell includes an electrocatalyst; and a counter electrode. The electrocatalyst includes a nickel foam substrate; and a layer of particles of a FeNi alloy on the surface of the nickel foam substrate. The particles of the FeNi alloy are in the form of nanosheets, wherein the nanosheets have an average width of 1-5 micrometers (μm) and an average length of 1-10 μm, and wherein the nanosheets are vertically aligned to form a flower shape.

In some embodiments, the nanosheets have an average thickness of less than 40 nanometers (nm).

In some embodiments, the nanosheets are vertically aligned perpendicular to the nickel foam substrate.

In some embodiments, the nanosheets comprise quantum dots with an average size of 1-10 nm, which are encased within the nanosheets.

In some embodiments, the flower shapes are interconnected and form a hierarchical structure.

In some embodiments, the FeNi alloy comprises 45-55 at % Fe, and 45-55 at % Ni, based on a total number of atoms in the FeNi alloy.

In some embodiments, the particles of the FeNi alloy do not include oxygen.

In some embodiments, the particles of the FeNi alloy consist of Fe and Ni.

In some embodiments, the particles of the FeNi cover an entire surface of the nickel foam substrate.

In some embodiments, a method of forming the electrocatalyst is described. The method includes forming the electrocatalyst by mixing an iron salt and a nickel salt in a solvent to form a homogeneous solution; and depositing the homogeneous solution on the nickel foam substrate by aerosol-assisted chemical vapor deposition (AACVD) at a temperature of 400-600° C. to form the electrocatalyst.

In some embodiments, the method includes depositing the homogeneous solution on the nickel foam substrate for 60-120 minutes.

In some embodiments, the method includes depositing the homogeneous solution on the nickel foam substrate with a carrier gas, wherein the carrier gas comprises 1-20 vol % H₂ and 80-99 vol % N₂.

In some embodiments, the electrocatalyst has an overpotential of 300-350 millivolts (mV) for a current density of 50-500 milliampere per square centimeter (mA cm⁻²).

In some embodiments, the overpotential does not vary by more than 5% after the potential is applied for 1-100 hours.

In some embodiments, the electrocatalyst consists of FeNi on the surface of the nickel foam substrate.

In some embodiments, the aqueous solution includes at least one base selected from the group consisting of an alkaline earth metal hydroxide and an alkali metal hydroxide.

In some embodiments, the base is potassium hydroxide.

In some embodiments, the counter electrode is made from a material selected from the group consisting of platinum, gold, and carbon.

The foregoing general description of the illustrative present disclosure and the following The detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method of forming an electrocatalyst, according to certain embodiments;

FIG. 2 is an X-ray diffraction (XRD) pattern of iron-nickel (Fe—Ni) alloy films grown on plain glass for a time period of 1 hour (designated as FeNi-1) and 2 hours (designated as FeNi-2) via aerosol-assisted chemical vapor deposition (AACVD), according to certain embodiments;

FIG. 3A-FIG. 3B shows scanning electron microscopic (SEM) images of the FeNi alloy catalysts deposited on nickel foam (NF) substrate for 1 hour, at 50 μm scale, and 1 μm scale, respectively, according to certain embodiments;

FIG. 3C-FIG. 3D shows SEM images of the FeNi alloy catalysts deposited on the NF substrate for 2 hours, at 50 μm scale, and 1 μm scale, respectively, according to certain embodiments;

FIG. 4A shows energy dispersive X-ray spectroscopy (EDX) spectra of the FeNi-1 electrocatalyst by AACVD, according to certain embodiments;

FIG. 4B shows elemental maps of Fe and Ni elements of the FeNi-1 electrocatalysts, according to certain embodiments;

FIG. 4C shows EDX spectra of the FeNi-2 electrocatalyst by AACVD, according to certain embodiments;

FIG. 4D shows elemental maps of Fe and Ni elements of the FeNi-2 electrocatalysts, according to certain embodiments;

FIG. 5A shows a transmission electron microscopic (TEM) analysis of the FeNi-2 catalyst at 50 nm scale, according to certain embodiments;

FIG. 5B shows a TEM analysis of the FeNi-2 catalyst at 20 nm scale, according to certain embodiments;

FIG. 5C shows a high-resolution transmission electron microscope (HR-TEM) image at 5 nm presenting the lattice fringes of Ni, according to certain embodiments;

FIG. 5D shows a Selected Area Electron Diffraction (SAED) image showing the ring formation for a polycrystalline nature of Ni, according to certain embodiments;

FIG. 6A shows concurrent 1st and 25th cyclic voltammetry (CV) curves for the FeNi/Ni-1h catalyst (FeNi alloy on the NF substrate obtained after 1 hour of AACVD deposition), recorded at a scan rate of 50 mV sec⁻¹ in 1.0 M KOH electrolyte solution, according to certain embodiments;

FIG. 6B shows concurrent 1st and 25th CV curves for the FeNi/Ni-2h catalyst (FeNi alloy on the NF obtained after 1 hour of AACVD deposition), recorded at a scan rate of 50 mV sec⁻¹ in 1.0 M KOH electrolyte solution, according to certain embodiments;

FIG. 7A shows polarization curves at a scan rate of 5 mV/s in 1.0 M KOH electrolyte solution for the FeNi/Ni catalysts deposited over the NF substrate at various deposition times, according to certain embodiments;

FIG. 7B shows a zoomed view of the polarization curves of FIG. 7A, according to certain embodiments;

FIG. 7C shows a Tafel slope for the FeNi/Ni catalysts compared with bare NF and IrO₂/NF catalysts, according to certain embodiments;

FIG. 7D shows Nyquist plots for the FeNi/Ni catalysts compared with bare NF and IrO₂/NF catalysts, according to certain embodiments;

FIG. 7E shows turnover frequency (TOF) values for the FeNi/Ni catalysts (recorded at various potentials directly from polarization curves), according to certain embodiments;

FIG. 7F shows a plot of current exchange density for the FeNi/Ni catalysts, according to certain embodiments;

FIG. 8A shows cycling stability test of the FeNi/Ni-2h catalyst for 5000 cycles, at a scan rate of 50 mVs⁻¹ in 1.0 MKOH electrolyte solution, according to certain embodiments;

FIG. 8B shows chronopotentiometry response (η vs t) of the FeNi/Ni-2h catalyst at two different applied current densities of 10 and 25 mA cm⁻² in 1.0 M KOH electrolyte solution, according to certain embodiments; and

FIG. 8C shows polarization curves of the FeNi/Ni-2h catalyst before and after the experiments, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, “particle size” and “pore size” may be thought of as the lengths or longest dimensions of a particle and of a pore opening, respectively.

As used herein, the term “nanoparticle” refers to a particle of matter having at least one dimension that is between 1 and 1,000 nanometers in size.

As used herein, the term “electrode” refers to an electrical conductor used to contact a non-metallic part of a circuit e.g., a semiconductor, an electrolyte, a vacuum, or air.

As used herein, the term “current density” refers to the amount of electric current traveling per unit cross-section area.

As used herein, the term “Tafel slope” refers to the relationship between the overpotential and the logarithmic current density.

As used herein, the term “aerosolizing” refers to a process of intentionally oxidatively converting and suspending particles or a composition in a moving stream of air for the purpose of delivering the oxidized particles or composition to a particular location.

As used herein, the term “aerosol” refers to extremely small solid particles, or very small liquid droplets, suspended in the atmosphere.

As used herein, the term “electrochemical cell” refers to a device capable of either generating electrical energy from chemical reactions or using electrical energy to cause chemical reactions.

As used herein, the term “water splitting” refers to the chemical reaction in which water is broken down into oxygen and hydrogen.

2H₂O→2H₂+O₂

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of naturally occurring nickel ²⁸Ni include ⁵⁸Ni, ⁶⁰Ni, ⁶¹Ni, ⁶²Ni, and ⁶⁴Ni. Isotopes of iron include ⁵⁴Fe, ⁵⁶Fe, ⁵⁷Fe, and ⁵⁸Fe. Isotopes of oxygen include ¹⁶O, ¹⁷O, and ¹⁸O. Isotopically labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed to an iron-nickel (FeNi) alloy for oxygen evolution reaction (OER), particularly in nanoparticle form. Thin films of the FeNi alloy were produced by using the aerosol-assisted chemical deposition (AACVD) method and examined for their OER catalytic activity.

According to an aspect of the present disclosure, an electrocatalyst, also referred to as a catalyst, is described. The electrocatalyst includes a substrate onto which is dispersed a layer of metallic particles. In an embodiment, the substrate is made from at least one metal selected from the group consisting of Mn, Fe, Co, and Ni. In an embodiment, the substrate is in the form of a foam, a mesh, or a solid metal sheet. As used herein a metal foam is a cellular structure consisting of a solid metal with gas-filled pores comprising a large portion of the volume. In a preferred embodiment, the substrate is nickel foam (NF). In an embodiment, at least 80-99% of the nickel foam substrate is porous, preferably 85%, 90%, or 95%. In an embodiment, the average pore size of the NF substrate is about 50 to 500 micrometers (μm), preferably 100-400 μm, or about 200-300 μm. In an embodiment, the substrate has a thickness of 0.1 to 10 mm, preferably 0.5 to 8 mm, 1 to 5 mm or 2-3 mm. Also, the pores may have many shapes, such as cubical, conical, cuboidal, pyramidical, or cylindrical. In an embodiment, the pores of the NF substrate have a spherical shape.

The electrocatalyst further includes a layer of particles of FeNi alloy that at least partially covers the surface of the NF substrate. It is preferred that the particles of FeNi alloy form a uniform layer that completely covers the surface of the NF substrate. In some embodiments, the layer of particles of FeNi alloy covers only a front surface of the NF substrate or both a front and a back surface. The particles of FeNi alloy cover at least 50%, preferably 55%, preferably 60%, preferably 65%, preferably 70%, preferably 75%, preferably 80%, preferably 85%, preferably 90%, and preferably >95% of the NF substrate. In an embodiment, the particles of the FeNi alloy consist of Fe and Ni, which cover the entire surface of the nickel foam substrate.

In some embodiments, the particles of FeNi comprise 45-55, preferably 45-50, and preferably 47-49 at. % Fe, and 45-55, preferably 50-55, preferably 51-53 at. % Ni, based on the total number of atoms in the FeNi alloy. In some embodiments, the particles of FeNi alloy further comprises another transition metal selected from the group consisting of scandium, titanium, vanadium, chromium, manganese, cobalt, copper, and zinc. In a preferred embodiment, the particles of FeNi consist of Fe and Ni. The particles of the FeNi alloy do not include oxygen.

In some embodiments, the electrocatalyst includes a co-catalyst. In an especially preferred embodiment, the electrocatalyst does not include a co-catalyst. As used herein, the term ‘co-catalyst’ refers to the substance or agent that brings about catalysis in conjunction with one or more others. In a more preferred embodiment, the co-catalyst does not include platinum. In the most preferred embodiment, the co-catalyst does not include any precious metals such as gold, silver, ruthenium, rhodium, palladium, osmium, iridium, and platinum. In a more preferred embodiment, the substrate and catalyst do not include platinum. In the most preferred embodiment, the substrate and catalyst do not include any precious metals such as gold, silver, ruthenium, rhodium, palladium, osmium, iridium, and platinum. In a preferred embodiment, the electrocatalyst consists of FeNi on the surface of the nickel foam substrate.

In a preferred embodiment, the electrocatalyst does not include or require a binding compound to promote the interaction of the FeNi alloy with the surface of the substrate. The binding compound may include polymeric binding compounds such as Nafion, fluorinated polymers, such as polyvinylidene fluoride and polytetrafluoroethylene, nylon, polyethylene, polyester, polyvinyl alcohol, Teflon, and epoxy. The binding compound may also include organic compounds such as N-methyl-2-pyrrolidone (NMP), N,N-dimethyl formamide (DMF), N,N-dimethyl acetamide (DMAc), and dimethyl sulfoxide (DMSO). In some embodiments, the binding compound is not included in the entire electrocatalyst or just in the layer of the FeNi particles on the surface of the substrate.

The FeNi alloy particles include particles in the form of nanosheets. In some embodiments, the of FeNi alloy particles may exist in other morphological forms such as nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc. and mixtures thereof. In some embodiments, at least 80 wt. % of FeNi alloy particles, preferably at least 85 wt. % of FeNi alloy particles, preferably at least 90 wt. % of FeNi alloy particles, preferably at least 95 wt. % of FeNi alloy particles are in the form of nanosheets.

In some embodiments, the nanosheets have an average diameter of width of 1-5 μm, preferably 1-4, or 2-3 μm an average length of 1-10 μm, preferably 2-9, 3-8, 4-7, or 5-6 μm and an average thickness of less than 40 nm, preferably 5-40, 10-35, 15-30, or 20-25 nm. In some embodiments, the nanosheets are randomly oriented on the surface of the nickel foam substrate. In some embodiments, the nanosheets are oriented vertically or horizontally on the surface of the nickel foam substrate. In a preferred embodiment, the nanosheets are vertically aligned perpendicular to the nickel foam substrate to form a flower shape. In some embodiments, the flower shapes form an interconnected and continuous hierarchical structure. In other words, there are not islands of the flowers but rather they are continuously connected. The nanosheets further include quantum dots with an average size of 1-10 nm, preferably 2-9, 3-8, 4-7, or 5-6 nm which are encased within the nanosheets. In some embodiments, the quantum dots are only iron or only nickel quantum dots. In some embodiments, the quantum dots the quantum are an alloy of nickel and iron.

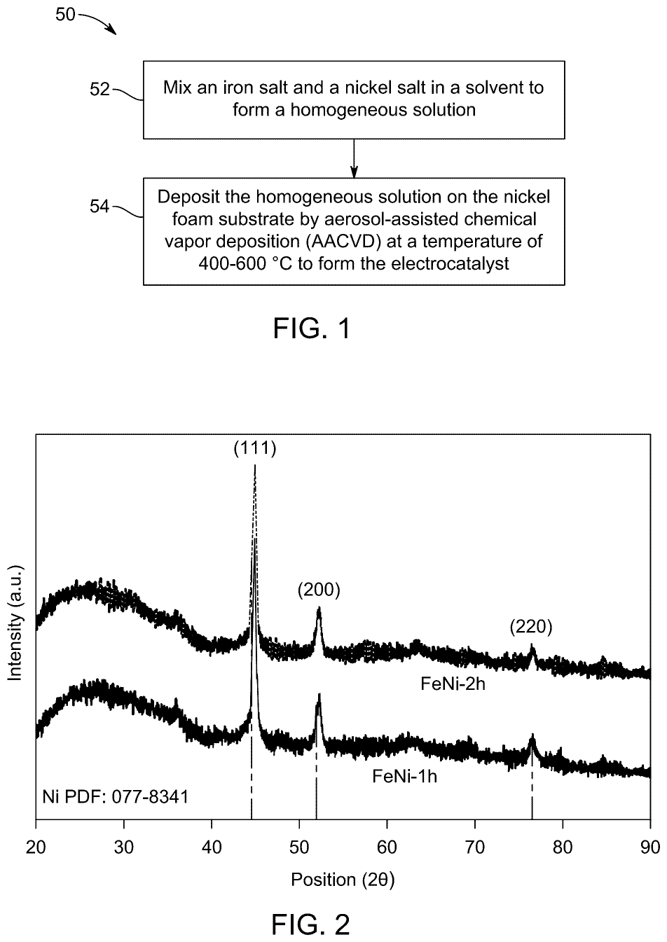

FIG. 1 illustrates a flow chart of a method 50 of preparing the electrocatalyst. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing a nickel salt and an iron salt in a solvent to form a homogeneous solution. Suitable examples of iron salts include ferrous sulfate, ferric sulfate; ferrous chloride; ferric nitrate; ferrous nitrate; ferric sulfate; ferric chloride; iron (III) acetylacetonate (Fe(acac)₃), iron acetate, and mixtures and hydrates thereof. Preferably the iron salt is iron acetylacetonate. Suitable examples of Ni salts include, but are not limited to, nickel(II) nitrate, nickel(II) acetate, nickel(II) acetylacetonate, nickel(II) hexafluoroacetylacetonate, nickel(II) octanoate, ammonium nickel(II) sulfate, nickel(II) chloride, nickel(II) bromide, nickel(II) fluoride, nickel(II) iodide, nickel(II) carbonate, nickel(II) hydroxide, nickel(II) perchlorate, nickel(II) sulfate, nickel(II) sulfamate, and mixtures and hydrates thereof. Preferably, Ni salt is nickel(II) acetylacetonate. In some embodiments, the nickel salt and the iron salt are mixed in a 1-10:1-10 molar ratio, preferably 1:5 to 5:1 molar ratio, preferably 1:4 to 4:1 molar ratio, preferably 3:1 to 1:3 molar ratio, preferably 1:to 2:1 molar ratio, and more preferably a 1:1 molar ratio, in the solvent. The solvent is at least one selected from the group consisting of a ketone solvent, an ester solvent, an alcohol solvent, an amide solvent, and an ether solvent. In some embodiments, the solvent is the alcohol solvent. In some embodiment, the alcohol solvent is at least one selected from the group consisting of methanol, ethanol, n-propanol, and isopropanol, preferably methanol. The mixing may be carried out manually or with the help of a stirrer. It is carried out till the nickel salt and the iron salt are fully dissolved in the solvent, methanol, resulting in a homogenous solution.

At step 54, the method 50 includes depositing the homogeneous solution on the nickel foam substrate by aerosol-assisted chemical vapor deposition (AACVD) at a temperature of 400-600° C. to form the electrocatalyst. The AACVD process involves atomizing the homogenous solution into fine, sub-micrometer-sized aerosol droplets, which are delivered to a heated reaction zone, where the aerosol droplets undergo evaporation, decomposition, and homogeneous and/or heterogeneous chemical reactions to form the desired products. Using the AACVD route, a batch of films with different thicknesses and morphologies can be fabricated in a very short time. This can be achieved by controlling parameters, such as deposition temperature, deposition time, gas carrier flow rate, precursor, and concentration of the precursor solution, to name a few. The aerosolizing process may be performed on an aerosol generator. Many different types of aerosol generators are known and may be used depending on the film desired. The AACVD process is maintained at a temperature range of 400 to 600° C., preferably 420-580° C., preferably 450 to 550° C., preferably 400-500° C., more preferably to about 475° C. At this temperature, the solvent from the aerosol evaporates, leaving behind the precursor. The thickness depends on how long the deposition process takes place. The deposition is carried out with a carrier gas, wherein the carrier gas comprises 1-20 vol % H₂ and 80-99 vol % N₂, preferably 1-10 vol % H₂ and 90-99 vol % N₂, or 1-5 vol % H₂ and 95-99 vol % N₂. In a preferred embodiment, the carrier gas does not include oxygen. In an embodiment, the deposition process is carried out for a period of 30-150 minutes, preferably 40-130 minutes, preferably 50-120 minutes, preferably 60-120 minutes, to obtain the electrocatalyst. The electrocatalyst thus prepared includes FeNi on the surface of the nickel foam substrate.

In an embodiment, a method of generating oxygen is described. The method includes applying a potential of greater than 0 to 2.0 V preferably 0.2 to 1.8 V, 0.4 to 1.6 V, 0.6 to 1.4 V, 0.8 to 1.2 V, or about 1 V, to an electrochemical cell. On applying the potential the aqueous solution is oxidized, thereby forming oxygen. The electrochemical cell includes the electrocatalyst of the present disclosure, and a counter electrode. During the electrochemical process, the electrochemical cell is at least partially submerged preferably 50%, preferably at least 60%, 70%, 80%, 90%, or fully submerged in the aqueous solution.

The electrocatalyst forms the working electrode, while the counter electrode forms the auxiliary electrode. The outer surface of the counter electrode includes an inert, electrically conducting chemical substance, such as platinum, gold, or carbon. The carbon may be in the form of graphite or glassy carbon. Alternatively, the counter electrode may comprise some other electrically-conductive material such as platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻⁸ Ω·m at a temperature of 20-25° C. In one embodiment, the counter electrode may be a wire, a rod, a cylinder, a tube, a scroll, a sheet, a piece of foil, a woven mesh, a perforated sheet, or a brush. The counter electrode material should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or lead to undesirable contamination of either electrode.

The aqueous solution includes water and an inorganic base. The base, also referred to as the electrolyte, is selected from the group consisting of an alkaline earth metal hydroxide such as beryllium hydroxide (Be(OH)₂), magnesium hydroxide (Mg(OH)₂), strontium hydroxide (Sr(OH)₂), and calcium hydroxide (Ca(OH)₂) and an alkali metal hydroxide such as lithium hydroxide (LiOH), sodium hydroxide (NaOH), potassium hydroxide (KOH) and rubidium hydroxide (RbOH), and cesium hydroxide (CsOH). In a preferred embodiment, the base is potassium hydroxide. The concentration of the base may lie in a range of about 0.1 molar (M) to 3 M, more preferably 1-2.5 M, and yet more preferably 1.5-2.5 M.

The water may be tap water, distilled water, bidistilled water, deionized water, deionized distilled water, reverse osmosis water, and/or some other water. In one embodiment, the water is bidistilled to eliminate trace metals. Preferably the water is bidistilled, deionized, deionized distilled, or reverse osmosis water and at 25° C. has a conductivity at less than 10 μS·cm⁻¹, preferably less than 1 μS·cm⁻¹, a resistivity greater than 0.1 MΩ·cm, preferably greater than 1 MΩ·cm, more preferably greater than 10 MΩ·cm, a total solid concentration less than 5 mg/kg, preferably less than 1 mg/kg, and a total organic carbon concentration less than 1000 μg/L, preferably less than 200 μg/L, more preferably less than 50 μg/L.

In some embodiments, the working electrode and the counter-electrode are connected to each other by way of electrical interconnects that allow for the passage of current between the electrodes, when a potential is applied between them. In a preferred embodiment, the electrocatalyst (which forms the working electrode) and the counter electrode are at least partially submerged in the water and are not in physical contact with each other. In an embodiment, the working electrode and the counter-electrode can have the same or different dimensions. In certain embodiments, the working electrode has a cross-section diameter of 1.68 mm, and the counter-electrode as a cross-section diameter of 0.2 mm.

In one embodiment, the electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode or the counter electrode. The reference electrode may be a standard hydrogen electrode (SHE), a normal hydrogen electrode (NHE), a reversible hydrogen electrode (RHE), a saturated calomel electrode (SCE), a copper-copper(II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, or some other type of electrode. In a preferred embodiment, a reference electrode is present and is a silver chloride electrode (Ag/AgCl). However, in some embodiments, the electrochemical cell does not include a third electrode.

Preferably, to maintain uniform concentrations and/or temperatures of the electrolyte solution, the electrolyte solution may be stirred or agitated during the step of the applying. The stirring or agitating may be done intermittently or continuously. This stirring or agitating may be done by a magnetic stir bar, a stirring rod, an impeller, a shaking platform, a pump, a sonicator, a gas bubbler, or some other device. Preferably the stirring is done by an impeller or a magnetic stir bar.

Preferably, the FeNi alloy-electrode functions as the anode, receiving a positive potential to oxidize OH⁻ into O₂ gas and H₂O, while the counter electrode functions as the cathode, receiving a negative potential to reduce water into H₂ gas and OH⁻. This is summarized by the following reactions:

2H₂O(ₗ)+2e⁻→H_{2(g)}+2OH⁻_{(aq)}Cathode(reduction)

4OH⁻_{(aq)}→O_{2(g)}+2H₂O₍ₗ₎+4e⁻Anode(oxidation)

2H₂O₍ₗ₎→2H_{2(g)}+O_{2(g)}Overall reaction

In another embodiment, the potentials may be switched, wherein the FeNi alloy-electrode functions as the cathode and receives a negative potential, and the counter electrode functions as the anode and receives a positive potential. In an alternative embodiment, the electrodes may be subjected to an alternating current (AC) in which the anode and cathode roles are continually switched between the two electrodes.

In one embodiment, the potential may be applied to the electrodes by a battery, such as a battery including one or more electrochemical cells of alkaline, lithium, lithium-ion, nickel-cadmium, nickel metal hydride, zinc-air, silver oxide, and/or carbon-zinc. In another embodiment, the potential may be applied through a potentiostat or some other source of direct current, such as a photovoltaic cell. In one embodiment, a potentiostat may be powered by an AC adaptor, which is plugged into a standard building or home electric utility line. In one embodiment, the potentiostat may connect with a reference electrode in the electrolyte solution. Preferably the potentiostat is able to supply a relatively stable voltage or potential. For example, in one embodiment, the electrochemical cell is subjected to a voltage that does not vary by more than 5%, preferably by no more than 3%, preferably by no more than 1.5% of an average value throughout the subjecting. In another embodiment, the voltage may be modulated, such as being increased or decreased linearly, being applied as pulses, or being applied with an alternating current. Preferably, the FeNi alloy-electrode may be considered the working electrode, with the counter electrode being considered the auxiliary electrode. However, in some embodiments, the FeNi alloy-electrode may be considered the auxiliary electrode with the counter electrode.

In one embodiment, the method further comprises the step of separately collecting H₂-enriched gas and O₂-enriched gas. In one embodiment, the space above each electrode may be confined to a vessel in order to receive or store the evolved gases from one or both electrodes. The collected gas may be further processed, filtered, or compressed. Preferably the H₂-enriched gas is collected above the cathode, and the O₂-enriched gas is collected above the anode. The electrolytic cell, or an attachment, may be shaped so that the headspace above the FeNi alloy-electrode is kept separate from the headspace above the reference electrode. In one embodiment, the H₂-enriched gas and the O₂-enriched gas are not 100 vol % H₂ and 100 vol % O₂, respectively. For example, the enriched gases may also comprise N₂ from the air, water vapor, and other dissolved gases from the electrolyte solution. The H₂-enriched gas may also comprise O₂ from the air. The H₂-enriched gas may comprise greater than 20 vol % H₂, preferably greater than 40 vol % H₂, more preferably greater than 60 vol % H₂, and even more preferably greater than 80 vol % H₂, relative to a total volume of the receptacle collecting the evolved H₂ gas. The O₂-enriched gas may comprise greater than 20 vol % O₂, preferably greater than 40 vol % O₂, more preferably greater than 60 vol % O₂, and even more preferably greater than 80 vol % O₂, relative to a total volume of the receptacle collecting the evolved O₂ gas. In some embodiments, the evolved gases may be bubbled into a vessel comprising water or some other liquid, and higher concentrations of O₂ or H₂ may be collected. In one embodiment, evolved O₂ and H₂, or H₂-enriched gas and O₂-enriched gas, may be collected in the same vessel.

Several parameters for the method for decomposing water may be modified to lead to different reaction rates, yields, and other outcomes. These parameters include but are not limited to electrolyte type and concentration, pH, pressure, solution temperature, current, voltage, stirring rate, electrode surface area, size of FeNi alloy particles, porosity, and exposure time. A variable DC current may be applied at a fixed voltage, or a fixed DC current may be applied at a variable voltage. In some instances, AC current or pulsed current may be used. A person having ordinary skill in the art may be able to adjust these and other parameters, to achieve different desired nanostructures. In other embodiments, the electrochemical cell may be used for other electrochemical reactions or analyses.

The electrocatalyst has an overpotential of 300-350 millivolts (mV), preferably 310-340, or 320-330 mV for a current density of 50-500 milliamperes per square centimeter (mA cm⁻²). Also, the overpotential does not vary by more than 5%, preferably 4%, 3%, 2%, or 1% after the potential is applied for 1-100 hours, indicating the long-term stability of the electrocatalyst. Overpotential in electrolysis refers to the extra energy required than thermodynamically expected to drive a reaction. To make the process commercially viable, a low overpotential is required.

One factor for assessing OER kinetics is the Tafel slope. The Tafel slope shows how efficiently an electrode can produce current in response to a change in applied potential. Therefore, a low Tafel slope indicates that less overpotential is required to get a high current. The electrocatalyst has a Tafel slope of 39-69 mV/decade, preferably 45-65, 50-60 or about 55 mV/decade which is much lower than the bare substrate (195 mV/decade), indicating that the electrocatalyst of the present disclosure facilitates the energy-intensive step during the OER process. In one embodiment, the FeNi alloy-electrode may have a higher current density than a bare electrode (nickel foam substrate or NF substrate), where the bare electrode has essentially the same structure without particles of FeNi alloy.

While not wishing to be bound to a single theory, it is thought that the unique nanosheet flower structure of the FeNi made by the AACVD synthesis method improves catalytic activity. The petal networks facilitate the contact between the electrolyte ions and the catalyst material and provide more active centers at the surface that can enhance the OER performance. In addition, the interconnected porous structure on the alloy and the NF substrate can facilitate the fast diffusion of electrons, thereby accelerating the electrocatalytic reaction.

In an alternative embodiment, the electrocatalyst of the present disclosure may be used in the field of batteries, fuel cells, photochemical cells, water splitting cells, electronics, water purification, hydrogen sensors, semiconductors (such as field effect transistors), magnetic semiconductors, capacitors, data storage devices, biosensors (such as redox protein sensors), photovoltaics, liquid crystal screens, plasma screens, touch screens, OLEDs, antistatic deposits, optical coatings, reflective coverings, anti-reflection coatings, and/or reaction catalysis.

### EXAMPLES

The following examples demonstrate a method of generating oxygen using an electrocatalyst as described herein. The examples are provided solely for illustration and are not to be construed as limitations of the present disclosure, as many variations thereof are possible without departing from the spirit and scope of the present disclosure.

### Example 1: Reagents and Materials

The study used the following chemicals: iron (III) acetylacetonate (Fe(acac)₃), nickel(II) acetylacetonate (Ni(acca)₂), and methanol were purchased from Sigma-Aldrich. Nickel foam (1.6 mm thick and 95% porosity) was purchased from Good-fellow Cambridge Ltd. The water used throughout all experiments was Milli-Q water.

### Example 2: Synthesis of the FeNi Electrocatalyst

The nickel foam (NF) strips of size (1 cm×2 cm) were pre-cleaned with diluted HCl, acetone, and ethanol for 10 min each in an ultrasonic bath. Then, the NF was rinsed with deionized water and blown with high-purity N₂ gas. The iron-nickel alloy (FeNi) thin film electrocatalyst was developed on Ni foam using an in-house built aerosol-assisted chemical vapor deposition (AACVD). The solution of a dual precursor of Fe(acac)₃ (100 mg, 0.283 mmol) and Ni(acac)₂ (73 mg, 0.283 mmol) was prepared in 15 mL of methanol. The aerosol mist from the dual precursor solution was produced using an ultrasonic humidifier, and a mist stream was transferred to a horizontal tube furnace preheated at 475° C. with the help of carrier gas (10% H₂+90% N₂). The NF in the tube furnace was positioned to receive the precursor nebula directly over it, where the decomposition of precursor and chemical vapor deposition (CVD) reactions took place to develop a layer of FeNi material. The deposition process was repeated for a period of 1 h and 2 h, respectively, and the prepared samples were named FeNi/Ni-1h and FeNi/Ni-2h, respectively. After completing the deposition experiments, the aerosol supply was closed, and 100% H₂ gas was passed over the catalyst films to ensure the FeNi alloy formation.

### Example 3: Structural Characterization Methods

The catalyst morphology was seen with a scanning electron microscope (SEM) JEOL JSM-6610LV (Japan). Energy-dispersive X-ray spectrometer (EDX, INCA Energy 200, Oxford Instruments, UK) was used to find the elemental composition of the catalyst. The crystalline structure over a 2θ range of 20-90° was recorded with X-ray diffraction (XRD, Rigaku MiniFlex X-ray diffractometer (Japan)) was used to measure the crystalline pattern of the films over a 2θ range of 20-90°. The TEM measurement analysis was performed using JEOL-JEM2100F, Japan, operating at an acceleration voltage of 200 kV. X-ray photoelectron spectroscopy (XPS, Thermo Scientific EscaLab 250Xi, USA) with an A1 Kα (1486.6 eV) source was performed to examine the chemical composition and valence states. The electron beam was calibrated with C 1s (284.6 eV) as standard.

### Example 4: Electrochemical Measurement Methods

A computer-controlled Autolab potentiostat workstation with Nova 2.1.6. interface was used to investigate electrocatalytic water oxidation by FeNi/Ni film electrodes. A typical three-electrode cell was set up with a platinum (Pt) rod, Ag/AgCl, and the FeNi film electrodes as the counter, reference, and working electrodes, respectively. The electrochemical tests were conducted in 1.0 M KOH electrolyte, and the potential readings were converted to the reversible hydrogen electrode (RHE). To activate the catalyst surface for water oxidation, cyclic voltammetry (CV) analysis in the potential range of 1-2 V (vs. RHE) was performed. The linear sweep voltammetry (LSV) test at a scan rate of 5 mVs-1 was carried out, and data are reported with iR corrections. Electrochemical impedance spectroscopy (EIS) at a potential of 1.50 V in the frequency range from 0.01 Hz to 100 kHz was observed. The long-term catalytic durability was evaluated using the chronopotentiometry (CP) method for a time period of 100 h.

### Example 5: Structure and Morphology Characterization

The iron-nickel (FeNi) alloy films were fabricated for time periods of 1 and 2 h using the AACVD method. FIG. 2 shows the XRD patterns of obtained FeNi alloy films on plain glass. The peaks at 2θ of 45°, 52.3°, and 76.7° resulted from reflection planes of (111), (200), and (220), respectively, and correspond to the bulk nickel (PDF: 077-8341). The characteristic Fe peaks are missing owing to the formation of Fe—Ni alloy. From FIG. 2, it is noted that the XRD peaks of the standard “Ni” are slightly shifted to a higher 2θ value in the case of Fe—Ni samples, which could be attributed to the lattice narrowing when the Ni atoms are replaced by Fe atoms with a smaller radius.

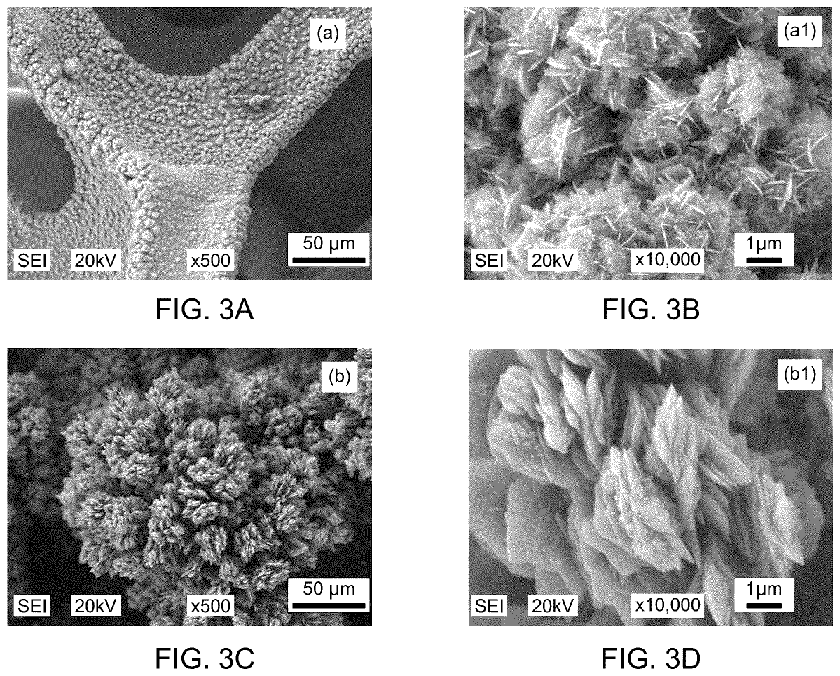

FIG. 3 shows the SEM morphology of FeNi alloy catalyst produced on nickel foam as a result of 1 and 2h, deposition via AACVD. The FeNi/Ni-1h alloy shows the formation and distribution of small-sized crystallites over a large area of NF struts (FIG. 3A and FIG. 3B). The design, shape, and texture of this crystallite become visible in the high-magnification image, which resembles with blooming flower-like pattern and is decorated with regularly interconnected petal features. The direct deposition for 2h developed a significantly large and thick plant-like object, and its corresponding high-magnification image clearly shows the vertically aligned petals, which are stacked together to create another flower pattern (FIG. 3C and FIG. 3D). The development of hierarchical flower-like structures in both catalyst samples seems fluffy and porous, presenting a high surface area with uniform distribution of catalytic active sites. The 3D NF with hierarchical and porous petal networks offers a promising platform for various applications such as water splitting, supercapacitors, and hydrogen storage The petal networks facilitate the contact between the electrolyte ions and the catalyst material. The FeNi petals synthesized after 2 h of deposition time have more active centers at the surface that can enhance the OER performance. These active centers are influenced by the surface structure, nanoparticle shape/size, and electrolyte composition.

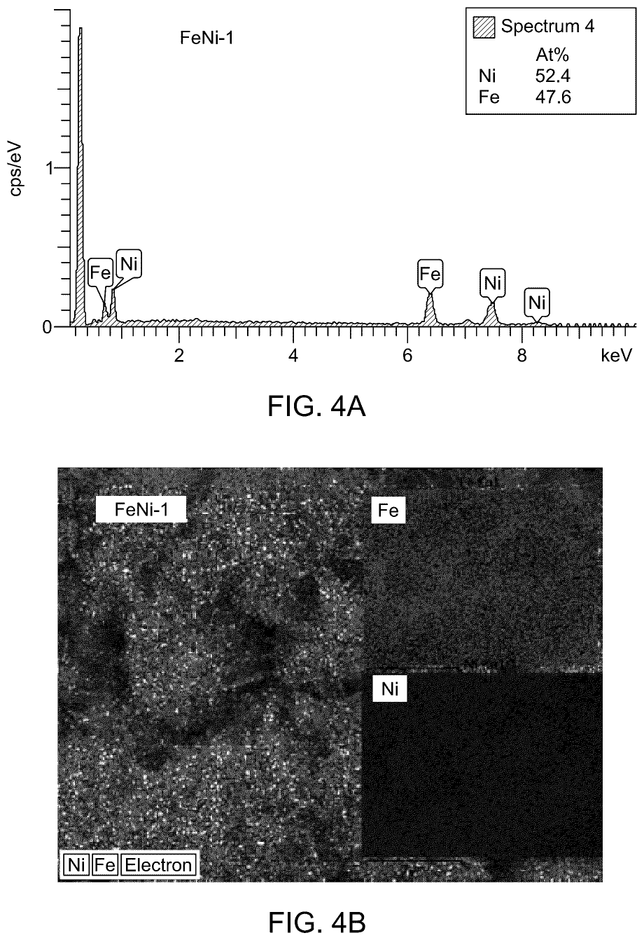

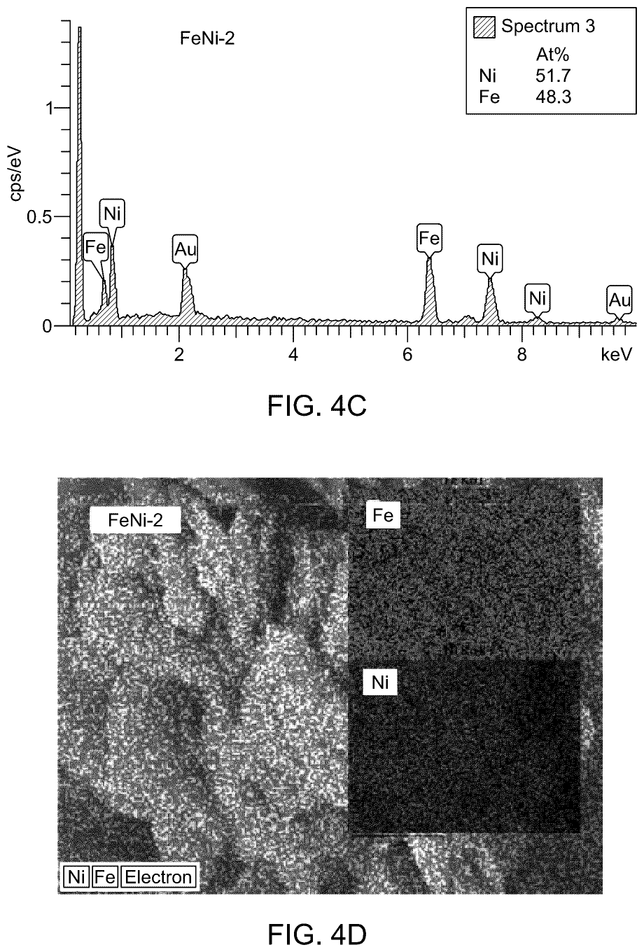

The elemental composition of the FeNi alloy catalyst was investigated by EDX analysis. For this, the catalyst film prepared on a plain glass was used to avoid the addition of Ni from the nickel foam substrate, which would increase the concentration of Ni present in the as-synthesized catalyst samples. The presence of Fe and Ni elements indicates the synthesis of FeNi catalysts, and the Au peaks are attributed to the gold coating used to avoid the charging effect under SEM. The percent (%) atomicity in FeNi-1 alloy catalyst is found to be 47.6/52.4 (FIG. 4A) and 48.3/51.7 for the FeNi-2 alloy catalyst (FIG. 4C), representing an empirical elemental ratio between Fe:Ni atoms nearly 1:1. The absence of oxygen (O) elements indicates the synthesis of pure alloy material. Additionally, the EDX map analysis (FIG. 4B and FIG. 4D) confirmed that Fe and Ni atoms are homogeneously and uniformly distributed in the alloy materials.

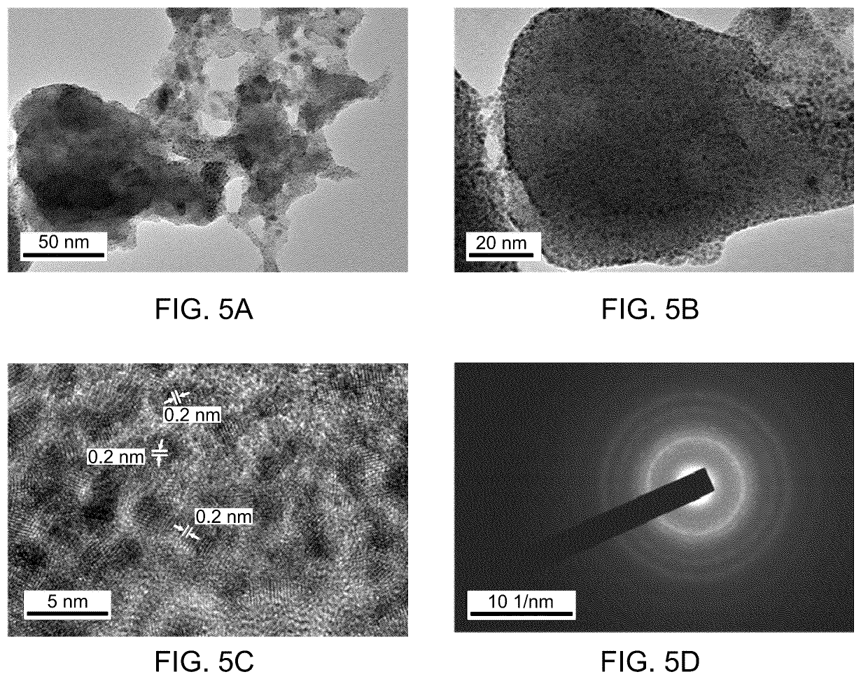

The nanostructure of the FeNi-2h catalyst was further analyzed by TEM analysis (FIG. 5). The nano-sheet-like morphology found in TEM images (FIG. 5A and FIG. 5B), indicates a good correlation with the SEM result. The TEM images show the presence of quantum dots of size 2-4 nm inside these nanosheets. Although it is hard to identify Fe and Ni atoms, the value of the characteristic spacing is 0.20 nm, corresponding well to the high intensity (111) crystal facet of metallic nickel as observed in XRD data. The HR-TEM at 5 nm depicts the lattice fringes of Ni (FIG. 5C). Furthermore, the selected area electron diffraction pattern (SAED) shows the formation of symmetrical rings demonstrating the poly-crystalline nature of the FeNi alloy catalyst (FIG. 5D).

### Example 6: Electrochemical Characterization

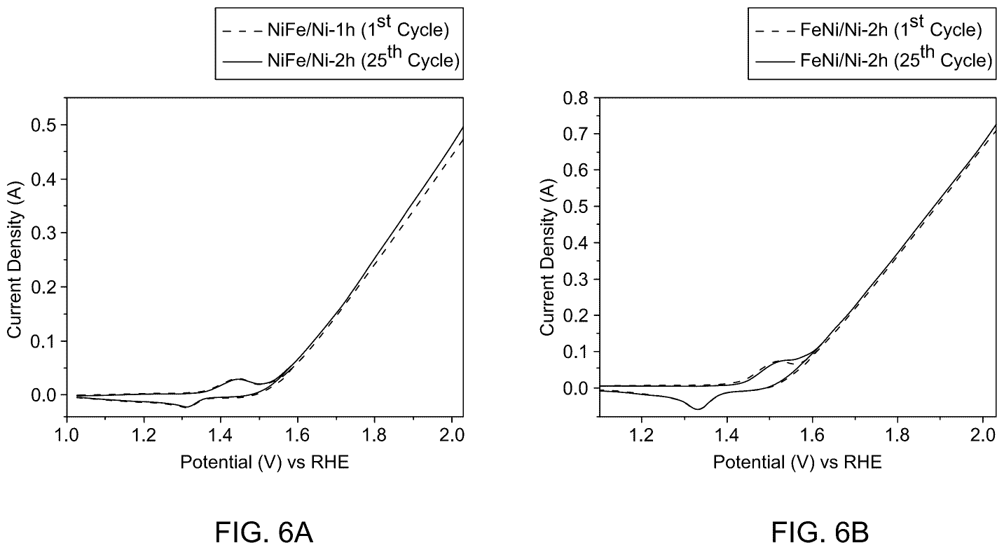

The OER characteristics of the FeNi electrocatalyst were investigated by assembling a three-electrode cell connected with a potentiostat in a 1.0 M KOH electrolyte. Initially, the catalytic films were activated by conducting concurrent cyclic voltammetry (CV) test, which promotes active species on the surface of the catalyst. The result of 25 continuous CV scans of both FeNi catalysts are shown in FIG. 6A and FIG. 6B. The shape and features of the CVs revealed valuable information about the kinetics and mechanisms of the electrochemical reactions occurring at the electrode-electrolyte interface. In the CV plot, forward biasing produces an anodic peak in the region 1.4-1.5 V, which indicates the conversion of metallic species into high valent spices i.e., oxide/oxyhydroxide more active for breaking the hydroxyl ion (OH⁻) to produce oxygen. A slight variation in oxidation peak position is due to the composition and structure of the FeNi alloys, as well as the electrolyte conditions. Several possible explanations have been proposed for this shift in the anodic peak, such as—i) the formation of a metastable FeNi oxyhydroxide phase, which has a higher oxidation potential than NiOOH, ii) the incorporation of Fe into the NiOOH lattice, which modifies its electronic structure and catalytic properties, iii) the dissolution and re-deposition of Fe species from the electrolyte, which affects the surface morphology and composition of the FeNi alloys. As the CV progresses, the oxidation peak area becomes wider, which indicates that the in-situ formation of catalytic species is increasing.

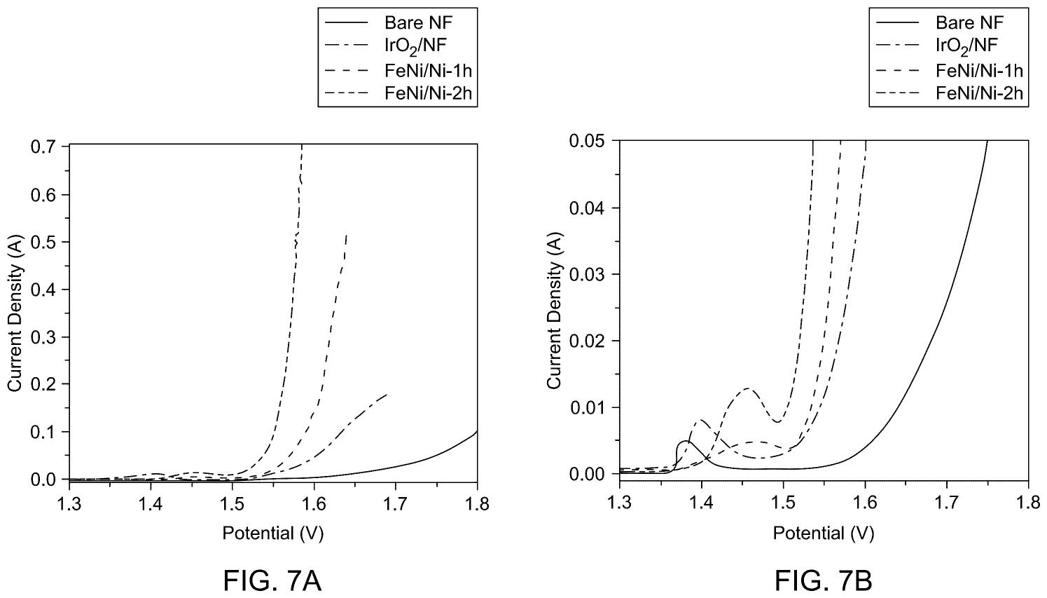

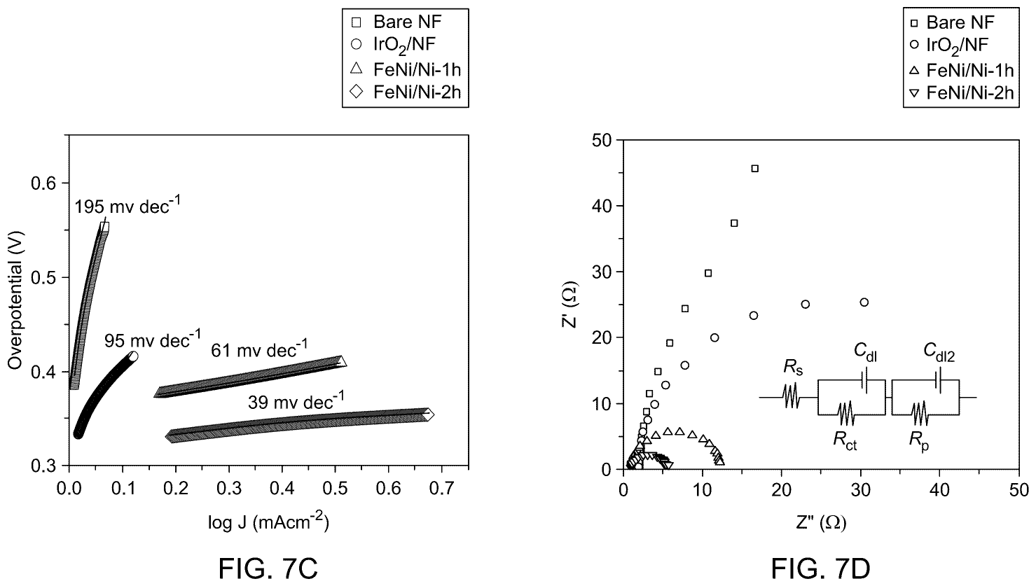

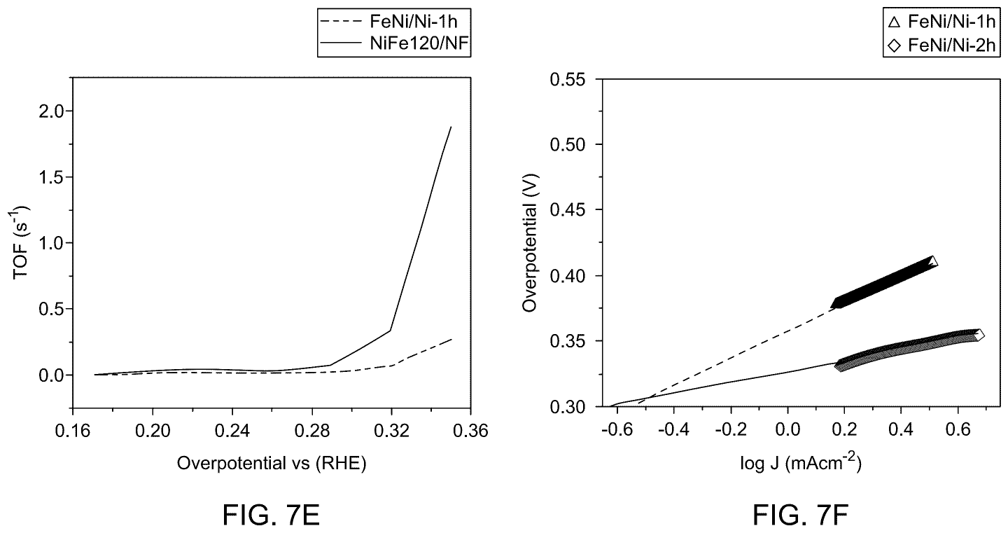

After surface activation and stabilization of the fabricated electrocatalysts, their OER performance was evaluated and compared using linear sweep voltammetry (LSV) performed in 1.0 M KOH solution at a scan rate of 5 mVs⁻¹. For comparison, bare NF and IrO₂-coated NF were also tested under similar conditions. FIG. 7A shows the polarization curves of all catalytic systems. Apparently, in all catalytic systems, the current density peak rapidly increases after 1.5 V. The comparative LSV curves clearly show that both FeNi/Ni-1h and FeNi/Ni-2h have better OER performance when compared with IrO₂/NF and bare NF. Particularly, FeNi/Ni-2h reaches a maximum current density of 700 mA cm⁻² at 1.57 V, while FeNi/Ni-1h only reaches a current density of 500 mA cm⁻² at higher potential 1.65 V, indicating a faster heterogeneous electron transfer process in FeNi/Ni-2h catalyst. The benchmark IrO₂ and bare nickel foam exhibit higher potentials and lower peak current densities compared to both FeNi catalysts. FIG. 7B presents the enlarged view of these LSV curves, which clearly show that water oxidation in FeNi/Ni-2h catalyst initiates a bit earlier (at 1.47 V,ηₒₙₛₑₜ=240 mV), to FeNi/Ni-1h catalyst (1.53 V ηₒₙₛₑₜ=300 mV), while both catalysts maintained a potential difference (Δη=40 mV) to reach 50 mAcm⁻². Nevertheless, to reach a current density of 50 mAcm⁻², FeNi/Ni-1h catalyst requires an overpotential of 340 mV, which is less than the benchmark IrO₂ (370 mV).

Further, the Tafel slope has been extracted from the polarization curves to compare the OER kinetics of different catalysts. The Tafel equation: η=a+b log j is used to fit the linear part of the Tafel curve and FIG. 7C shows that FeNi/Ni-2h has the lowest Tafel slope value of 39 mV dec⁻¹ followed by FeNi/Ni-1h (69 mV dec⁻¹) IrO₂ (95 mV dec⁻¹) and bare NF (195 mV dec⁻¹). The smaller Tafel value of the FeNi/Ni-2h catalyst indicates its ability to transfer charge at faster rates than other catalysts—thus, it has superior OER activity, much higher as compared to FeNi alloy catalysts, indicating a higher OER kinetics on the FeNi surface.

Further insight into electrocatalyst kinetics is obtained through electrochemical impedance spectroscopy (EIS), which describes the electrical resistance and interfacial charge transfer resistance (R_{ct}) between the surface of an electrode and H₂O/OH. The electrical conductivity of an electrode is a factor that modifies its efficacy. Typically, higher electrical conductivity results in a quicker charge transfer and, consequently, greater performance. FIG. 7D depicts the EIS Nyquist plots of all electrocatalysts (NF, IrO₂, FeNi/Ni-1h, and FeNi/Ni-2h) recorded at a potential of 1.5V_{RHE}. The resistance or kinetics of interfacial charge transfer near the electrode surface can be inferred from the semicircular dispersion in Nyquist plots. The semicircular arcs represent the frequency response of the transfer function in Cartesian coordinates. The smaller the arc, the lower the resistance or faster the charge transfer. A two-time constant parallel model was used to fit all EIS data, based on the Nyquist analysis that showed the existence of a circuit with two-time constants. This model consists of Rs in series with two parallel constant phase element-resistance. The Rs represents collective resistances, including wiring resistance (R_{wiring}) and solution resistance (Rₛₒₗᵤ). In addition, R_{ct}, Rₚ, represent respectively (summarized in Table 1), charge transfer resistance, surface (porous or irregular texture) resistance, and capacitance. The FeNi/Ni-2h catalyst demonstrates the lowest R_{ct} value and hence the better charge transport and conductivity as compared to the other electrocatalysts.

TABLE 1
The EIS parameters of NF, IrO₂, FeNi/Ni-1 h and FeNi/Ni-2 h

| Electrocatalyst | Rₛ | Rₚ | R_{ct} |
|---|---|---|---|
| NF | 2.1 | 22.2 | 2.10E+04 |
| IrO₂ | 1.9 | 0.11 | 51 |
| FeNi/Ni-1 h | 0.85 | 0.1 | 11.4 |
| FeNi/Ni-2 h | 1 | 1.8 | 2.8 |

In addition, the inherent catalytic activity of both FeNi electrocatalysts was assessed by measuring the turnover frequency (TOF) using the following formula:

$$TOF = \frac{j * A}{4 * F * m}$$

Where j stands for the current density, A is the geometric surface area (1 cm²) of the NF substrate, F is the Faraday constant of value 96,485 C mol⁻¹, and m is the number of moles of catalyst that have been deposited on the NF substrate. FIG. 7E indicates the TOF plot of FeNi electrocatalysts measured at various overpotentials. The FeNi/Ni-1h and FeNi/Ni-2h electrocatalyst exhibit TOF values of 0.25 s⁻¹ and 1.85 s⁻¹, respectively, at an overpotential of 350 mV. The FeNi/Ni-2h electrode has a significantly larger TOF value than its analog (FeNi-1h), which reveals it's highly conducting nature and superior OER activity. The intrinsic electrocatalytic activity was further evaluated by studying the exchange current density (J₀). The exchange current density reflects the electron transfer ability of the catalyst material. Electrocatalyst with higher current density needs less driving force to drive the charges. The exchange current density is obtained by extending the linear part of the Tafel curve to the X-axis (FIG. 7F). At zero overpotential, the log[j] values of FeNi/Ni-1h, and FeNi/Ni-2h are found to be 0.044 and 0.65, which corresponds to the J₀ values of 2.7, and 4.4 mA cm⁻², respectively. Again, the higher exchange current density of the FeNi/Ni-2h catalyst makes it remarkable for OER catalysis.

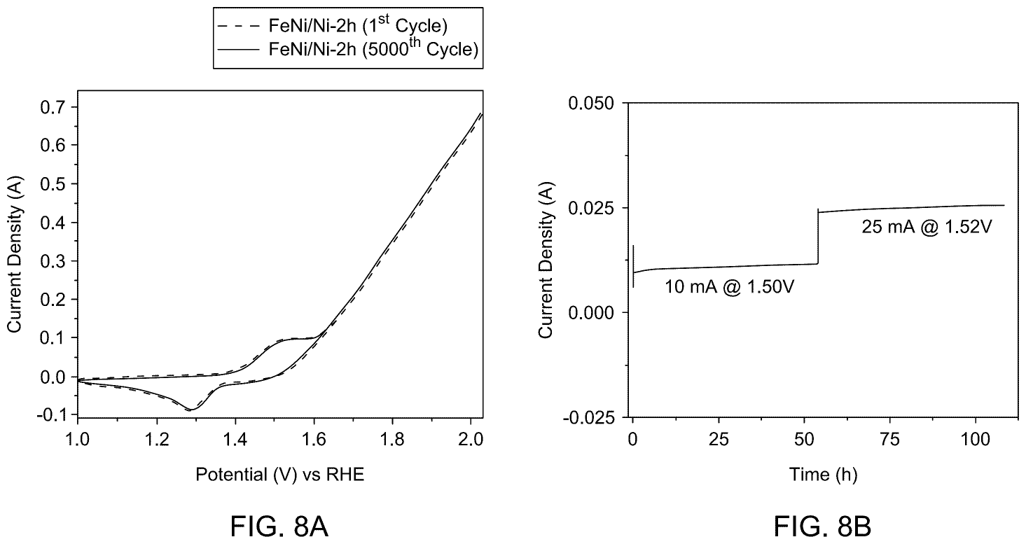

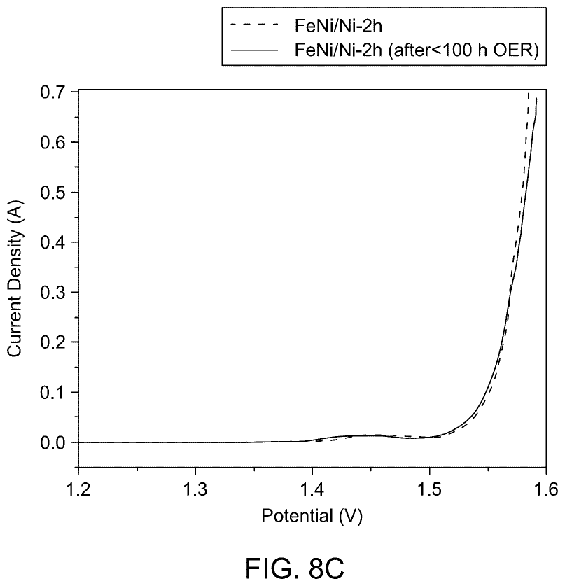

Besides the higher electrocatalytic activity, long-term OER stability is another factor that decides the suitability of the catalyst for practical demonstration. The FeNi/Ni-2h catalyst was subjected to prolonged OER measurements by two different kinds of tests. First, the catalyst was employed to continuous CV run for 5000 cycles, and the result of the 1^{st} and 5000^{th} cycles are compared in FIG. 8A, which has exactly the same profile. After CV, the CP test for more than 100 h was carried out by applying two potentials of 1.50 and 1.52 V, respectively, to observe the corresponding current profiles displayed in FIG. 8B, which shows a linear behavior. Both stability tests (CV and CP) witness the high stability and endurance of FeNi electrocatalyst under rigorous OER conditions. Right after the CP measurement, the polarization curve was measured again and compared with its response before the stability test, as shown in FIG. 8C. The polarization curve after the stability test is consistent with its initial behavior. The influential OER performance of the FeNi alloy thin film electrocatalyst can be attributed to the following factors: (i) the use of a proper deposition method based on AACVD to develop FeNi thin film directly on nickel foam support resulted in a robust electrocatalyst which enhanced the electrical conductivity of the catalyst (ii) The 2 h deposition yielded highly porous nanoflower structure providing abundantly available catalytic active sites to facilitate improved reaction kinetics (iii) porous and 3-D texture of Ni-foam as support, allows penetration, increased electron/ion transport paths, and excessively disperse electroactive phase.

Numerous modifications and variations of the present disclosure are possible in light of the above teachings. It is therefore to be understood that within the scope of the appended claims, the invention may be practiced otherwise than as specifically described herein.

1: A method of generating oxygen, comprising:
applying a potential of greater than 0 to 2.0 V to an electrochemical cell,
wherein the electrochemical cell is at least partially submerged in an aqueous solution,
wherein on applying the potential the aqueous solution is oxidized thereby forming oxygen,
wherein the electrochemical cell comprises:
an electrocatalyst; and
a counter electrode;
wherein the electrocatalyst comprises:
a nickel foam substrate; and
a layer of particles of an FeNi alloy on a surface of the nickel foam substrate,
wherein the particles of the FeNi alloy are in the form of nanosheets,
wherein the nanosheets have average width of 1-5 μm and an average length of 1-10 μm, and
wherein the nanosheets are vertically aligned to form a flower shape.

2: The method of claim 1, wherein the nanosheets have an average thickness of less than 40 nm.

3: The method of claim 1, wherein the nanosheets are vertically aligned perpendicular to the nickel foam substrate.

4: The method of claim 1, wherein the nanosheets comprise quantum dots with an average size of 1-10 nm, which are encased within the nanosheets.

5: The method of claim 1, wherein the flower shapes are interconnected and form a hierarchical structure.

6: The method of claim 1, wherein the FeNi alloy comprises 45-55 at % Fe, and 45-55 at % Ni, based on a total number of atoms in the FeNi alloy.

7: The method of claim 1, wherein the particles of the FeNi alloy do not comprise oxygen.

8: The method of claim 1, wherein the particles of the FeNi alloy consist of Fe and Ni.

9: The method of claim 1, wherein the particles of the FeNi cover an entire surface of the nickel foam substrate.

10: The method of claim 1, further comprising:
forming the electrocatalyst by:
mixing an iron salt and a nickel salt in a solvent to form a homogeneous solution; and
depositing the homogeneous solution on the nickel foam substrate by aerosol-assisted chemical vapor deposition (AACVD) at a temperature of 400-600° C. to form the electrocatalyst.

11: The method of claim 10, wherein the depositing is carried out for 60-120 minutes.

12: The method of claim 10, wherein the depositing is carried out with a carrier gas, wherein the carrier gas comprises 1-20 vol % H2 and 80-99 vol % N2.

13: The method of claim 1, wherein the electrocatalyst has an overpotential of 300-350 millivolts (mV) for a current density of 50-500 milliampere per square centimeter (mA cm⁻²).

14: The method of claim 13, wherein the overpotential does not vary by more than 5% after the potential is applied for 1-100 hours.

15: The method of claim 1, wherein the electrocatalyst consists of FeNi on the surface of the nickel foam substrate.

16: The method of claim 1, wherein the aqueous solution comprises at least one base selected from the group consisting of an alkaline earth metal hydroxide and an alkali metal hydroxide.

17: The method of claim 16, wherein the base is potassium hydroxide.

18: The method of claim 1, wherein the counter electrode is made from a material selected from the group consisting of platinum, gold, and carbon.
